(19) United States
(12) Patent Application Publication
(10) Pub. No.: US 2005/0226257 A1
(43) Pub. Date: Oct. 13, 2005

(54) Virtual local area network

(75) Inventors: Vahe Mirzabegian, Harvard, MA (US); Pawel Sowinski, Boylston, MA (US); Ajit Nayak, Westborough, MA (US); Stuart Green, Salem, NH (US)

Correspondence Address: FOGG AND ASSOCIATES, LLC, P.O. BOX 581339, MINNEAPOLIS, MN, 55458-1339, US

(73) Assignee: ADC Broadband Access Systems, Inc.

(21) Appl. No.: 10/812,681

(22) Filed: Mar. 30, 2004

(51) Int. Cl. H04L 12/66

(52) U.S. Cl. 370/401; 370/338

(57) ABSTRACT

Users are enabled to network multiple customer premises equipment (CPE) devices together to form a virtual local area network (VLAN) among CPE devices that access the Internet through different cable modems. In a preferred embodiment, each VLAN is associated with a unique security association identifier (SAID), which enables a cable modem termination system (CMTS) to implement a secondary level of security in its routing procedures. As a result, data packets addressed to one or more members of a VLAN can be encrypted using the corresponding SAID such that access to the data packets is restricted only to members of the appropriate VLAN.

### TECHNICAL FIELD

The present invention relates generally to the field of telecommunications networks and, in particular, to virtual local area networks.

### BACKGROUND

A local area network (LAN) is a network of computers that spans a relatively small area. LANs advantageously facilitate the sharing of resources, such as data or hardware devices, among the networked computers. For example, multiple computers networked together in a LAN can access a telecommunications network, such as the Internet, through a single, shared access device, such as a cable modem.

In some situations, it may be desirable to establish a LAN among computers that do not access the Internet through the same cable modem. However, it can be difficult to establish such a network using conventional telecommunications equipment and methods due to a number of issues.

For example, many cable modem termination systems (CMTS) operate in accordance with the data-over-cable service interface specification (DOCSIS), which is a broadcast medium. Because multiple cable modems often communicate with a single CMTS over a shared medium, it can be difficult to transmit data packets to members of a LAN through different cable modems with sufficient security to ensure that other users who are on the same shared medium but who are not members of the LAN cannot gain access to the data packets.

### SUMMARY OF THE INVENTION

These and other drawbacks associated with existing telecommunications systems are addressed by embodiments of the present invention and will be understood by reading and studying the following specification.

In one embodiment, a method for routing data packets within a telecommunications system comprises receiving a data packet at a CMTS, determining whether the data packet satisfies a selected condition and, if so, encrypting the data packet. The method further comprises transmitting the data packet from the CMTS to the intended recipient(s).

In another embodiment, a method for registering a cable modem with a CMTS comprises receiving a request to register the cable modem and assigning a service identifier to the cable modem. The method further comprises determining whether the cable modem should be associated with a VLAN and, if so, assigning a multicast SAID associated with the VLAN to the cable modem.

In another embodiment, a CMTS comprises a network port configured to be coupled to a telecommunications network and a cable port configured to be coupled to one or more cable modems through which CPE devices can gain access to the telecommunications network. The CMTS further comprises a packet forwarding module in communication with the network port and the cable port and a VLAN bridging module in communication with the packet forwarding module. The VLAN bridging module is configured to determine whether a received data packet satisfies a selected condition and, if so, encrypt the data packet before it is delivered to the intended recipient(s).

In another embodiment, a CMTS comprises a network port configured to be coupled to a telecommunications network and a cable port configured to be coupled to one or more cable modems through which CPE devices can gain access to the telecommunications network. The CMTS further comprises a cable modem registration module in communication with the network port and the cable port. The cable modem registration module is configured to assign a primary service identifier to the cable modems when they are registered with the CMTS. The CMTS further comprises a VLAN bridging module in communication with the cable modem registration module. The VLAN bridging module is configured to determine whether a cable modem should be included in a VLAN and, if so, assign a secondary service multicast security association identifier to the cable modem.

In another embodiment, a machine readable medium comprises machine readable instructions for causing a computer to perform a method. The method comprises receiving a data packet at a CMTS, determining whether the data packet satisfies a selected condition and, if so, encrypting the data packet. The method further comprises transmitting the data packet from the CMTS to the intended recipient(s).

Other embodiments are described and claimed.

### BRIEF DESCRIPTION OF THE DRAWINGS

FIG. 1 is a block diagram of a telecommunications system in accordance with one embodiment of the present invention.

FIG. 2 is a flow chart illustrating a process for registering a cable modem with a cable modem termination system in accordance with one embodiment of the present invention.

FIG. 3 is a flow chart illustrating a process for routing data packets in accordance with one embodiment of the present invention.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

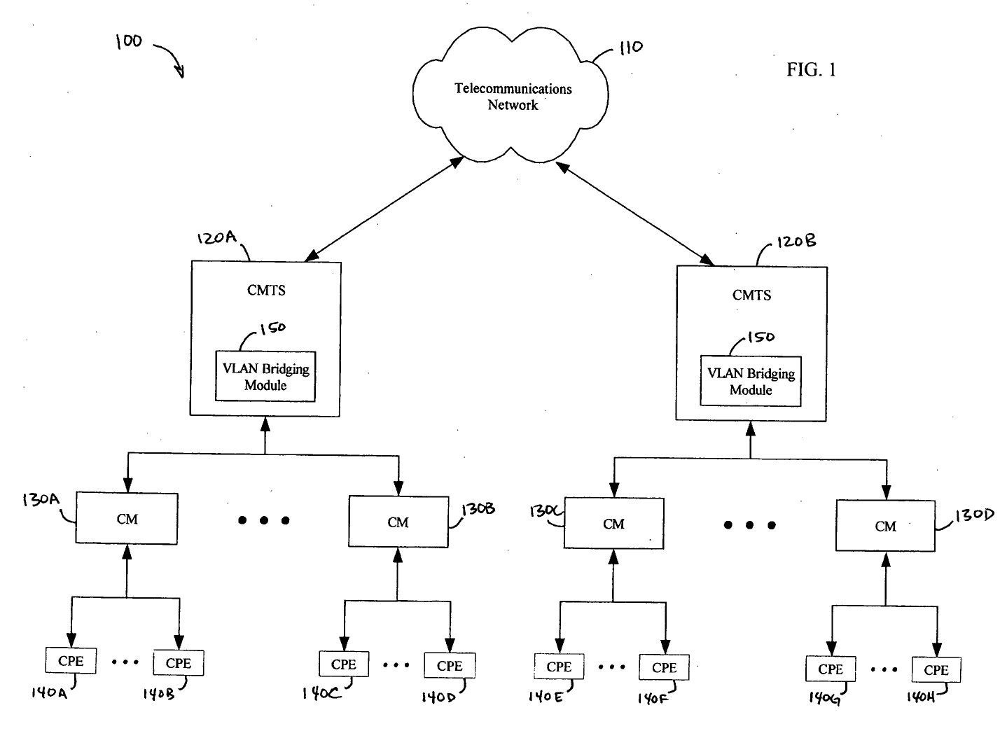

FIG. 1 is a block diagram of a telecommunications system 100 in accordance with one embodiment of the present invention. In the embodiment illustrated in FIG. 1, the telecommunications system 100 comprises a telecommunications network 110, such as, for example, the Internet, and a plurality of cable modem termination systems (CMTS) 120 in communication with the telecommunications network 110. In some embodiments, each CMTS 120 communicates with the telecommunications network 110 via a network port. The telecommunications system 100 further comprises a plurality of cable modems 130 in communication with the CMTSs 120 and with customer premises equipment (CPE) 140. In some embodiments, each CMTS 120 communicates with the cable modems 130 via a cable port, and operates in accordance with the data-over-cable service interface specification (DOCSIS). In addition, each CMTS 120 typically comprises several standard modules, such as, for example, cable modem registration, packet forwarding, and traffic policing modules, which perform well-known functions using techniques that are understood by those of ordinary skill in the art.

In some embodiments, the CPE devices 140 comprise computers, personal digital assistants, cellular telephones, and/or other devices that can be used by individual customers to gain access to the telecommunications network 110. In operation, data packets can be transmitted to and from a customer's CPE device 140 over the telecommunications network 110 using a variety of techniques that are well-known to those of ordinary skill in the art.

For example, in some embodiments, each cable modem 130 is registered with the appropriate CMTS 120, and is assigned a unique service identifier (SID). Each CPE device 140, in turn, has a unique destination address, such as, for example, a media access control (MAC) address. The CMTS 120 learns the associations between SIDs and MAC addresses and, as data packets are received, the CMTS 120 routes them to the appropriate cable modem 130 which, in turn, passes them along to the appropriate CPE device 140. Those of skill in the art will understand that numerous intermediate steps and/or alternative steps can be performed in connection with the routing of data packets within the telecommunications system 100.

As illustrated in FIG. 1, a plurality of CPE devices 140 can be networked together such that they gain access to the telecommunications network 110 through a single cable modem 130. For example, CPE 140A may be networked together with CPE 140B to form a local area network (LAN), which may include additional CPE devices 140. This arrangement advantageously facilitates the sharing of resources, such as, for example, data or hardware devices, among the CPE devices 140 that are members of the LAN.

In some situations, it may be desirable to establish a LAN among CPE devices 140 that are not coupled to the same cable modem 130. For example, it may be desirable to network together CPE devices 140A, 140B, 140C, 140D to form a LAN. Such a network, which includes CPE devices 140 that are not coupled to the same cable modem 130, is referred to as a virtual LAN (VLAN) or a transparent LAN (TLAN). In some embodiments, each CMTS 120 comprises a VLAN bridging module 150, which handles the management and packet routing issues associated with VLANs, as described below. The VLAN bridging module 150 is often coupled to and operates in coordination with other modules within the CMTS 120, such as, for example, the cable modem registration module and/or the packet forwarding module.

As illustrated in FIG. 1, multiple cable modems 130 are typically in communication with a single CMTS 120 over a shared medium. Therefore, multicast data packets transmitted to one cable modem 130 may be accessible to other cable modems 130 in communication with the same CMTS 120 over the same shared medium. For example, a multicast packet intended for distribution to the CPE devices 140 within a VLAN may be accessible to other CPE devices 140 sharing the same transmission medium.

One approach for preventing such undesired access to a multicast data packet is to convert the multicast packet into a plurality of unicast packets individually addressed to the intended recipients. This approach is somewhat inefficient, however, because it requires the CMTS 120 to create multiple copies of each multicast packet and then transmit the same packet to each recipient individually.

Accordingly, in a preferred embodiment of the present invention, a secondary security association is created among the cable modems 130 within a VLAN such that multicast packets can be transmitted along the shared medium, and cable modems 130 not within the VLAN cannot gain access to the packets. In some embodiments, each VLAN is associated with a unique encryption key that is used by the VLAN bridging module 150 to encrypt VLAN multicast packets before they are transmitted along the shared medium by the CMTS 120. Because the VLAN bridging module 150 enables multicast packets to be transmitted securely to the cable modems 130 within a VLAN, it acts as a “bridge” over which data can be transmitted to the CPE devices 140 comprising the members of the VLAN.

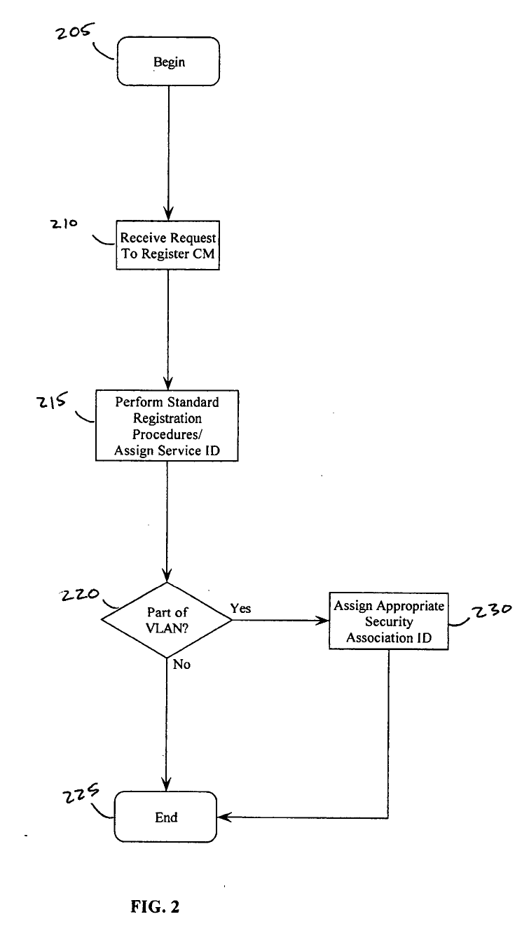

FIG. 2 is a flow chart illustrating a process for registering a cable modem 130 with a CMTS 120 in accordance with one embodiment of the present invention. In a first step 205, the process begins. In a next step 210, the CMTS 120 receives a request to register a new cable modem 130. In a step 215, the CMTS 120 performs a series of standard registration procedures, including the assignment of a unique SID to the cable modem 130, as described above.

In a step 220, the VLAN bridging module 150 of the CMTS 120 determines whether the cable modem 130 should be included in a VLAN. In some embodiments, this determination is made by requesting the user, during the registration process, to indicate whether the cable modem 130 is part of a VLAN and, if so, to provide authentication information for verification of the user's identity.

If the cable modem 130 is not part of a VLAN, then in a step 225, the process ends. Otherwise, in a step 230, the VLAN bridging module 150 assigns a secondary. SID, or security association identifier (SAID), to the cable modem 130. In some embodiments, each VLAN is associated with a unique SAID. Thus, if the cable modem 130 is being added to an existing VLAN, then during step 230, the VLAN bridging module 150 assigns the SAID associated with the existing VLAN to that cable modem 130. On the other hand, if the cable modem 130 is becoming the first member of a new VLAN, then during step 230, the VLAN bridging module 150 creates a new SAID, which is assigned to the cable modem 130. In some embodiments, once an appropriate SAID has been assigned, the CMTS 120 instructs the cable modem 130 to request authorization to use the SAID, after which the cable modem 130 receives an encryption key associated with the VLAN. The registration process then ends in step 225.

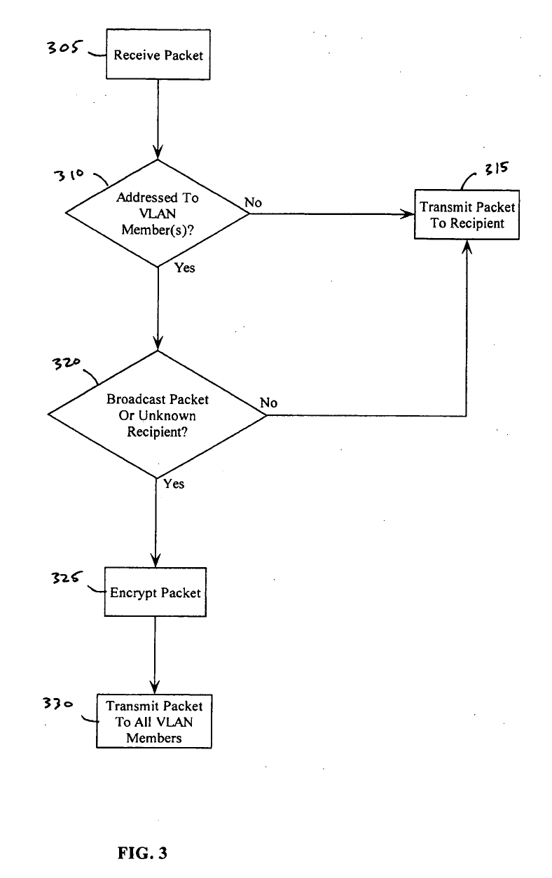

FIG. 3 is a flow chart illustrating a process for routing data packets in accordance with one embodiment of the present invention. In a first step 305, a data packet, such as, for example, an Ethernet packet, is received by a CMTS 120. In a next step 310, the VLAN bridging module 150 of the CMTS 120 determines whether the data packet is addressed to one or more members of a VLAN. In some embodiments, this determination is made by referencing a flag in a header segment of the data packet, which is set to a selected value if the data packet is addressed to a CPE device 140 that is a member of a VLAN. If the packet is not addressed to a VLAN member, then in a step 315, the data packet is transmitted to the intended recipient using conventional routing techniques that are well-known to those of ordinary skill in the art.

However, if the data packet is addressed to one or more a CPE devices 140 that are VLAN members, then in a step 320, the VLAN bridging module 150 determines whether: (a) the data packet is intended for broadcast to all VLAN members, or (b) the data packet is “flooded,” meaning that it is addressed to a particular VLAN member whose destination address is unknown by the CMTS 120. If neither of these conditions apply, then in a step 315, the data packet is routed to the known VLAN member using conventional routing techniques, as described above.

On the other hand, if the data packet is a broadcast packet or a flooded packet, then in a step 325, the packet is encrypted using the encryption key associated with the VLAN. In some embodiments, only the data segment of the packet is encrypted during this step. After the data packet has been encrypted, in a step 330, the packet is transmitted along the shared medium to the members of the VLAN.

By encrypting data packets addressed to one or more VLAN members using the encryption key associated with the VLAN, access to the packets is advantageously restricted only to members of the VLAN. For example, once an encrypted data packet has been routed by the CMTS 120, each cable modem 130 within the VLAN will be able to decrypt the packet using the appropriate encryption key received during the registration process, as described above. Cable modems 130 not within the VLAN, on the other hand, will not be able to decrypt the packet and will discard it. As a result, only members of the VLAN will have access to the encrypted packet.

In addition, once an encrypted data packet has been delivered to VLAN members by the CMTS 120, the dissemination of the packet among the members of the VLAN will be controlled by the address field of the packet. For example, if the data packet is a broadcast packet, then the address field will include a selected value indicating that the packet is intended for broadcast to all VLAN members. Accordingly, each cable modem 130 associated with the VLAN will decrypt the packet and forward it to all CPE devices 140 within the VLAN.

On the other hand, if the data packet is a flooded packet, then the address field will include only the MAC address of the intended recipient. Therefore, although each cable modem 130 in the VLAN will be able to decrypt the packet, only the cable modem 130 associated with the addressed CPE device 140 will actually deliver the packet to the recipient. The remainder of the cable modems 130 in the VLAN will discard the packet because it is not addressed to an associated CPE device 140.

In some embodiments, a VLAN may comprise CPE devices 140 that are not coupled to the same CMTS 120. For example, the CPE devices 140A, 140B, 140G, 140H illustrated in FIG. 1 may be networked together to form a VLAN. In this case, if the CMTS 120A received a data packet intended for broadcast to all members of the VLAN, then the CMTS 120A would encrypt the packet and deliver it to the cable modem 130A, which would decrypt the packet and forward it to the CPE devices 140A, 140B, as described above. In addition, the CMTS 120A would flag the packet as a VLAN broadcast packet and transmit it to the CMTS 120B over the telecommunications network 110 to be delivered to the VLAN members in communication with the CMTS 120B. The packet would then be broadcast to the CPE devices 140G, 140H by the CMTS 120B in the same way.

The systems and methods described above present a number of distinct advantages over previous approaches. For example, enabling users to establish VLANs among CPE devices coupled to different cable modems and/or CMTSs advantageously facilitates the sharing of resources among relatively large groups of CPE devices. In addition, by associating each VLAN with a unique SAID and encryption key, packets can be encrypted efficiently to restrict access only to members of the VLAN. Moreover, because multicast packets can be transmitted securely over a shared medium to the cable modems within a VLAN, the CMTS does not need to convert each multicast packet into a plurality of unicast packets and deliver them individually to the intended recipients. These and other advantages will become apparent to those of skill in the art in light of the present disclosure.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

1. A method for routing data packets within a telecommunications system, the method comprising:
receiving a data packet at a CMTS;
determining whether the data packet satisfies a selected condition and, if so, encrypting the data packet; and
transmitting the data packet from the CMTS to the intended recipient(s).

2. The method of claim 1, wherein the CMTS operates in accordance with DOCSIS.

3. The method of claim 1, wherein determining whether the data packet satisfies a selected condition comprises determining whether the data packet is intended for broadcast to a plurality of VLAN members.

4. The method of claim 1, wherein determining whether the data packet satisfies a selected condition comprises determining whether the data packet is intended for delivery to a VLAN member with an unknown destination address.

5. The method of claim 1, wherein the data packet is encrypted such that access to the data packet is restricted to members of a VLAN.

6. The method of claim 5, wherein an encryption key associated with the VLAN is used to encrypt the data packet.

7. A method for registering a cable modem with a CMTS, the method comprising:
receiving a request to register the cable modem;
assigning a service identifier to the cable modem; and
determining whether the cable modem should be associated with a VLAN and, if so, assigning a SAID associated with the VLAN to the cable modem.

8. The method of claim 7, wherein the CMTS operates in accordance with DOCSIS.

9. The method of claim 7, wherein each VLAN is associated with a unique SAID.

10. The method of claim 7, wherein determining whether the cable modem should be associated with a VLAN comprises receiving an input from a user indicating whether the cable modem is part of a VLAN.

11. The method of claim 10, further comprising receiving authentication information from the user.

12. The method of claim 7, wherein if the cable modem should be associated with a VLAN, an encryption key associated with the VLAN is transmitted to the cable modem.

13. The method of claim 7, wherein if the cable modem should be associated with an existing VLAN, an existing SAID corresponding to the VLAN is assigned to the cable modem.

14. The method of claim 7, wherein if the cable modem should be associated with a new VLAN, a new SAID corresponding to the new VLAN is created and assigned to the cable modem.

15. A CMTS comprising:
a network port configured to be coupled to a telecommunications network;
a cable port configured to be coupled to one or more cable modems through which CPE devices can gain access to the telecommunications network;
a packet forwarding module in communication with the network port and the cable port; and
a VLAN bridging module in communication with the packet forwarding module, wherein the VLAN bridging module is configured to determine whether a received data packet satisfies a selected condition and, if so, encrypt the data packet before it is delivered to the intended recipient(s).

16. The CMTS of claim 15, wherein the CMTS operates in accordance with DOCSIS.

17. The CMTS of claim 15, wherein the selected condition comprises determining whether the data packet is intended for broadcast to a plurality of VLAN members.

18. The CMTS of claim 15, wherein the selected condition comprises determining whether the data packet is intended for delivery to a VLAN member with an unknown destination address.

19. The CMTS of claim 15, wherein the VLAN bridging module is configured to encrypt the data packet such that access to the data packet is restricted to members of a VLAN.

20. The CMTS of claim 19, wherein an encryption key associated with the VLAN is used to encrypt the data packet.

21. A CMTS comprising:
a network port configured to be coupled to a telecommunications network;
a cable port configured to be coupled to one or more cable modems through which CPE devices can gain access to the telecommunications network;
a cable modem registration module in communication with the network port and the cable port, wherein the cable modem registration module is configured to assign a primary service identifier to the cable modems when they are registered with the CMTS, and
a VLAN bridging module in communication with the cable modem registration module, wherein the VLAN bridging module is configured to determine whether a cable modem should be included in a VLAN and, if so, assign a secondary service security association identifier to the cable modem.

22. The CMTS of claim 21, wherein the CMTS operates in accordance with DOCSIS.

23. The CMTS of claim 21, wherein each VLAN is associated with a unique secondary service security association identifier.

24. The CMTS of claim 21, wherein the VLAN bridging module is configured to determine whether a cable modem should be associated with a VLAN by receiving an input from a user indicating whether the cable modem is part of a VLAN.

25. The CMTS of claim 21, wherein the VLAN bridging module is configured to receive authentication information from the user.

26. The CMTS of claim 21, wherein if a cable modem should be associated with a VLAN, the VLAN bridging module transmits an encryption key associated with the VLAN to the cable modem.

27. The CMTS of claim 21, wherein if the cable modem should be associated with an existing VLAN, the VLAN bridging module assigns an existing secondary service security association identifier corresponding to the VLAN to the cable modem.

28. The CMTS of claim 21, wherein if the cable modem should be associated with a new VLAN, the VLAN bridging module creates a new secondary service security association identifier corresponding to the new VLAN and assigns it to the cable modem.

29. A machine readable medium comprising machine readable instructions for causing a computer to perform a method comprising:
receiving a data packet at a CMTS;
determining whether the data packet satisfies a selected condition and, if so, encrypting the data packet; and
transmitting the data packet from the CMTS to the intended recipient(s).

30. The machine readable medium of claim 29, wherein the CMTS operates in accordance with DOCSIS.

31. The machine readable medium of claim 29, wherein determining whether the data packet satisfies a selected condition comprises determining whether the data packet is intended for broadcast to a plurality of VLAN members.

32. The machine readable medium of claim 29, wherein determining whether the data packet satisfies a selected condition comprises determining whether the data packet is intended for delivery to a VLAN member with an unknown destination address.

33. The machine readable medium of claim 29, wherein the data packet is encrypted such that access to the data packet is restricted to members of a VLAN.

34. The machine readable medium of claim 33, wherein a SAID associated with the VLAN is used to encrypt the data packet.
